(19) United States
(12) Patent Application Publication
(10) Pub. No.: US 2024/0088975 A1
(43) Pub. Date: Mar. 14, 2024

(54) Measurement Signals for Beam Selection

(71) Applicant: Telefonaktiebolaget LM Ericsson (publ), Stockholm (SE)

(72) Inventors: Joao Vieira, Hjärup (SE); Robert Baldemair, Solna (SE); Muris Sarajlic, Malmö (SE)

(21) Appl. No.: 18/280,295

(22) PCT Filed: Mar. 5, 2021
(86) PCT No.: PCT/EP2021/055635

§ 371 Date: Sep. 5, 2023

(51) Int. Cl. H04B 7/06; H04B 7/0456

(52) U.S. Cl. CPC H04B 7/0695; H04B 7/0456; H04B 7/0617; H04B 7/0639

(57) ABSTRACT

A method is disclosed which is performed in a transmitter device configured for transmission of measurement signals for beam selection. The method comprises determining a collection of linear combinations of transmission beams, wherein the transmission beams are of a set of available transmission beams. A cardinality, R, of the collection of linear combinations of transmission beams is lower than a cardinality, N, of the set of available transmission beams. Each transmission beam in the set of available transmission beams is comprised in at least one linear combination of transmission beams, and at least one of the linear combinations of transmission beams comprises less than all transmission beams of the set of available transmission beams. The method also comprises transmitting measurement signals to a receiver device, wherein each of the measurement signals corresponds to a linear combination of transmission beams from the collection of linear combinations of transmission beams. A method is also disclosed which is performed in a receiver device configured for performing measurements for beam selection. The method comprises receiving the measurement signals from a transmitter device, and performing measurements for beam selection on the measurement signals, for selection of a transmission beam from the set of available transmission beams. Corresponding apparatuses, communication devices, system, and computer program product are also disclosed.

### TECHNICAL FIELD

The present disclosure relates generally to the field of wireless communication. More particularly, it relates to approaches for beam selection in relation to beam forming applied in wireless communication.

### BACKGROUND

In wireless communication standards that rely on beamforming (e.g., fifth generation new radio (5G NR), IEEE 802.11 ay, etc.), an important procedure for the radio access node (e.g., base station (BS), or access point (AP)) is to find the best (or at least a good enough) transmission beam towards each user device (e.g., user equipment (UE), or station (STA)) that it serves. This is usually achieved by some type of training transmissions (also referred to as beam training, beam sounding, and beam sweeping).

One way to implement such a procedure (which is used in IEEE 802.11ac, for example) is to let the radio access node transmit a number of beams in different radio resources, and let the user device perform measurements for each transmitted beam to estimate, e.g., the downlink (DL) channel and/or the received signal-to-noise ratio (SNR) and/or the received signal strength (RSS). Then, the user device can report the measurement results to the radio access node and/or inform the radio access node regarding a desired beam selection determined based on the measurements.

The number of orthogonal transmission beams that must be transmitted to span the relevant beam space in such a training implementation is, typically, in the order of the number of antennas (or antenna elements) at the radio access node. Thus, for situations with a large number of antenna elements, the number of beams becomes substantial which makes this approach cumbersome. For example, a substantial amount of radio resources (e.g., time and/or frequency units) may need to be allocated for the training transmissions and the training contributes with a large amount of overhead signaling, both of which may impair system capacity.

Therefore, there is a need for more efficient approaches for beam selection. Preferably, such approaches require less radio resource (e.g., time and/or frequency) allocation and/or less signaling overhead than other approaches. Also preferably, such approaches achieve the same—or at least not substantially worse—results concerning beam selection as the approaches referred to above (e.g., in terms of signal-to-noise ratio, SNR, when the selected beam is used).

### SUMMARY

It should be emphasized that the term “comprises/comprising” (replaceable by “includes/including”) when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Generally, when an arrangement is referred to herein, it is to be understood as a physical product; e.g., an apparatus or a device. The physical product may comprise one or more parts, such as controlling circuitry in the form of one or more controllers, one or more processors, or the like.

It is an object of the present disclosure to provide approaches with which an efficient beam selection can be achieved.

A first aspect is a method performed in a transmitter device configured for transmission of measurement signals for beam selection. The method comprises determining a collection of linear combinations of transmission beams. The transmission beams are of a set of available transmission beams. A cardinality, R, of the collection of linear combinations of transmission beams is lower than a cardinality, N, of the set of available transmission beams. Each transmission beam in the set of available transmission beams is comprised in at least one linear combination of transmission beams. At least one of the linear combinations of transmission beams comprises less than all transmission beams of the set of available transmission beams. The method also comprises transmitting measurement signals to a receiver device. Each of the measurement signals corresponds to a linear combination of transmission beams from the collection of linear combinations of transmission beams.

In some embodiments, determining the collection of linear combinations of transmission beams comprises determining the cardinality, R, of the collection of linear combinations of transmission beams based on the cardinality, N, of the set of available transmission beams.

In some embodiments, the cardinality, R, of the collection of linear combinations of transmission beams is determined as the lowest R that satisfies N≤2^{R}—1.

In some embodiments, none of the linear combinations of transmission beams comprises all transmission beams of the set of available transmission beams.

In some embodiments, the method further comprises allocating, for each linear combination of transmission beams, a respective transmission power for each transmission beam of the set of available transmission beams that is comprised in the linear combination of transmission beams.

In some embodiments, a sum over the collection of linear combinations of transmission beams of the respective transmission powers allocated for a transmission beam is equal for all transmission beams of the set of available transmission beams.

In some embodiments, the respective transmission power for a transmission beam is inversely proportional to a number of linear combinations that the transmission beam is comprised in.

In some embodiments, determining the collection of linear combinations of transmission beams comprises selecting an l^{th} group of

$$( \begin{matrix}R \\ l\end{matrix} )$$

transmission beams from the set of N available transmission beams, letting each transmission beam of the l^{th} group be comprised in exactly l of the linear combinations, and letting each linear combination comprise exactly

$$( \begin{matrix}R - 1 \\ l - 1\end{matrix} )$$

transmission beams of the l^{th} group.

In some embodiments, determining the collection of linear combinations of transmission beams comprises iterating for l=1, . . . , L, wherein L≤R is the highest L that satisfies

$${\sum }_{n = 1}^{L} ( \begin{matrix}R \\ n\end{matrix} ) \leq N .$$

In some embodiments, determining the collection of linear combinations of transmission beams further comprises selecting an (L+1)^{th} group of less than

$$( \begin{matrix}R \\ L\end{matrix} )$$

transmission beams from the set of N available transmission beams, letting each transmission beam of the (L+1)^{th} group be comprised in exactly (L+1) of the linear combinations, and letting each linear combination comprise at most

$$( \begin{matrix}R - 1 \\ L\end{matrix} )$$

transmission beams of the (L+1)^{th} group.

In some embodiments, each transmission beam in the set of available transmission beams is comprised in exactly one group.

In some embodiments, determining the collection of linear combinations of transmission beams comprises splitting the set of available transmission beams into two or more subsets of available transmission beams, and determining separate collections of linear combinations of transmission beams for each of the subsets.

In some embodiments, the method further comprises receiving a transmission beam selection measurement report from the receiver device, and selecting a transmission beam from the set of available transmission beams in accordance with the received transmission beam selection measurement report.

In some embodiments, the method further comprises transmitting a communication signal using the selected transmission beam.

In some embodiments, each of the linear combinations of transmission beams of the collection of linear combinations of transmission beams is a unique linear combination.

In some embodiments, transmitting the measurement signals that correspond to each of the linear combinations of transmission beams comprises transmitting, for each of the linear combinations of transmission beams of the collection of linear combinations of transmission beams, a measurement signal that corresponds to the linear combination of transmission beams in a respective transmission time resource. At least some of the respective time resources are different.

In some embodiments, transmitting the measurement signals that correspond to each of the linear combinations of transmission beams comprises transmitting, for each of the linear combinations of transmission beams of the collection of linear combinations of transmission beams, a measurement signal that corresponds to the linear combination of transmission beams in a respective transmission frequency resource. At least some of the respective frequency resources are different.

In some embodiments, the method is applied during a training phase for beam selection.

In some embodiments, the transmitter device is configured to transmit by analog, or hybrid, beamforming.

A second aspect is a method performed in a receiver device configured for performing measurements for beam selection. The method comprises receiving measurement signals from a transmitter device. Each of the measurement signals corresponds to a linear combination of transmission beams from a collection of linear combinations of transmission beams. The transmission beams are of a set of available transmission beams. A cardinality, R, of the collection of linear combinations of transmission beams is lower than a cardinality, N, of the set of available transmission beams. Each transmission beam in the set of available transmission beams is comprised in at least one linear combination of transmission beams. At least one of the linear combinations of transmission beams comprises less than all transmission beams of the set of available transmission beams. The method also comprises performing measurements for beam selection on the measurement signals, for selection of a transmission beam from the set of available transmission beams.

In some embodiments, performing measurements for beam selection comprises determining a quality metric for each transmission beam of the set of available transmission beams.

In some embodiments, the method further comprises selecting a preferred transmission beam from the set of available transmission beams based on the measurements for beam selection.

In some embodiments, selecting the preferred transmission beam comprises determining, for each transmission beam in the set of available transmission beams, an average received power over all measurement signals that correspond to linear combinations comprising the transmission beam, and selecting a transmission beam that corresponds to a highest average received power as the preferred transmission beam.

In some embodiments, the method further comprises transmitting a transmission beam selection measurement report to the transmitter device for selection of the transmission beam from the set of available transmission beams.

In some embodiments, performing measurements for beam selection comprises subjecting the received measurement signals to matched filtering based on the collection of linear combinations of transmission beams.

A third aspect is a method in a system comprising a transmitter device configured for transmission of measurement signals for beam selection and a receiver device configured for performing measurements for beam selection. The method comprises determining, by the transmitter device, a collection of linear combinations of transmission beams. The transmission beams are of a set of available transmission beams. A cardinality, R, of the collection of linear combinations of transmission beams is lower than a cardinality, N, of the set of available transmission beams. Each transmission beam in the set of available transmission beams is comprised in at least one linear combination of transmission beams. At least one of the linear combinations of transmission beams comprises less than all transmission beams of the set of available transmission beams. The method also comprises transmitting, by the transmitter device, measurement signals to the receiver device. Each of the measurement signals corresponds to a linear combination of transmission beams from the collection of linear combinations of transmission beams. The method also comprises receiving, by the receiver device, the measurement signals from the transmitter device. The method also comprises performing, by the receiver device, measurements for beam selection on the measurement signals, for selection of a transmission beam from the set of available transmission beams.

A fourth aspect is a computer program product comprising a non-transitory computer readable medium, having thereon a computer program comprising program instructions. The computer program is loadable into a data processing unit and configured to cause execution of the method according to any of the first, second, and third aspects when the computer program is run by the data processing unit.

A fifth aspect is an apparatus configured for controlling transmission—from a transmitter device—of measurement signals for beam selection. The apparatus comprises controlling circuitry configured to cause determination of a collection of linear combinations of transmission beams. The transmission beams are of a set of available transmission beams. A cardinality, R, of the collection of linear combinations of transmission beams is lower than a cardinality, N, of the set of available transmission beams. Each transmission beam in the set of available transmission beams is comprised in at least one linear combination of transmission beams. At least one of the linear combinations of transmission beams comprises less than all transmission beams of the set of available transmission beams. The controlling circuitry is also configured to cause transmission of measurement signals to a receiver device. Each of the measurement signals corresponds to a linear combination of transmission beams from the collection of linear combinations of transmission beams.

In some embodiments, the controlling circuitry is further configured to cause performance of the method of the first aspect.

A sixth aspect is a transmitter device configured to transmit measurement signals for beam selection. The transmitter device is configured to determine a collection of linear combinations of transmission beams. The transmission beams are of a set of available transmission beams. A cardinality, R, of the collection of linear combinations of transmission beams is lower than a cardinality, N, of the set of available transmission beams. Each transmission beam in the set of available transmission beams is comprised in at least one linear combination of transmission beams. At least one of the linear combinations of transmission beams comprises less than all transmission beams of the set of available transmission beams. The transmitter device is also configured to transmit measurement signals to a receiver device. Each of the measurement signals corresponds to a linear combination of transmission beams from the collection of linear combinations of transmission beams.

In some embodiments, the transmitter device is further configured to perform the method of the first aspect.

The apparatus of the fifth aspect and/or the transmitter device of the sixth aspect is embodied as a radio access node in some embodiments.

A seventh aspect is a communication device (e.g., a radio access node) comprising the apparatus of the fifth aspect and/or the transmitter device of the sixth aspect.

An eighth aspect is an apparatus configured for controlling performance of measurements for beam selection. The apparatus comprises controlling circuitry configured to cause reception of measurement signals from a transmitter device. Each of the measurement signals corresponds to a linear combination of transmission beams from a collection of linear combinations of transmission beams. The transmission beams are of a set of available transmission beams. A cardinality, R, of the collection of linear combinations of transmission beams is lower than a cardinality, N, of the set of available transmission beams. Each transmission beam in the set of available transmission beams is comprised in at least one linear combination of transmission beams. At least one of the linear combinations of transmission beams comprises less than all transmission beams of the set of available transmission beams. The controlling circuitry is also configured to cause performance of measurements for beam selection on the measurement signals, for selection of a transmission beam from the set of available transmission beams.

In some embodiments, the controlling circuitry is further configured to cause performance of the method of the second aspect.

A ninth aspect is a receiver device configured to perform measurements for beam selection. The receiver device is configured to receive measurement signals from a transmitter device. Each of the measurement signals corresponds to a linear combination of transmission beams from a collection of linear combinations of transmission beams. The transmission beams are of a set of available transmission beams. A cardinality, R, of the collection of linear combinations of transmission beams is lower than a cardinality, N, of the set of available transmission beams. Each transmission beam in the set of available transmission beams is comprised in at least one linear combination of transmission beams. At least one of the linear combinations of transmission beams comprises less than all transmission beams of the set of available transmission beams. The receiver device is also configured to perform measurements for beam selection on the measurement signals, for selection of a transmission beam from the set of available transmission beams.

In some embodiments, the receiver device is further configured to perform the method of the second aspect.

The apparatus of the eighth aspect and/or the receiver device of the ninth aspect is embodied as a user equipment (UE) in some embodiments.

A tenth aspect is a communication device (e.g., a user equipment) comprising the apparatus of the eighth aspect and/or the receiver device of the ninth aspect.

An eleventh aspect is a system comprising a transmitter device configured for transmission of measurement signals for beam selection and a receiver device configured for performing measurements for beam selection. The transmitter device is configured to determine a collection of linear combinations of transmission beams. The transmission beams are of a set of available transmission beams. A cardinality, R, of the collection of linear combinations of transmission beams is lower than a cardinality, N, of the set of available transmission beams. Each transmission beam in the set of available transmission beams is comprised in at least one linear combination of transmission beams. At least one of the linear combinations of transmission beams comprises less than all transmission beams of the set of available transmission beams. The transmitter device is also configured to transmit measurement signals to the receiver device. Each of the measurement signals corresponds to a linear combination of transmission beams from the collection of linear combinations of transmission beams. The receiver device is configured to receive the measurement signals from the transmitter device. The receiver device is also configured to perform measurements for beam selection on the measurement signals, for selection of a transmission beam from the set of available transmission beams.

In some embodiments, any of the above aspects may additionally have features identical with or corresponding to any of the various features as explained above for any of the other aspects.

An advantage of some embodiments is that alternative and/or improved approaches for beam selection are provided.

The alternative approaches may, in some embodiments, be more efficient than other approaches for beam selection. Efficiency may, for example, be in terms of the amount of radio resources and/or signaling overhead needed for beam training.

The alternative approaches may, in some embodiments, require less resource (e.g., time and/or frequency) allocation and/or less signaling overhead than other approaches for beam selection.

The alternative approaches may, in some embodiments, achieve beam selection that has a quality/performance that is not severely deteriorated compared to other approaches for beam selection (e.g., in terms of resulting received SNR of the selected beam).

An advantage of some embodiments is that measurement signaling is provided which is suitable for transmitter architectures with hybrid beamforming.

An advantage of some embodiments is that measurement signaling is provided which is suitable for fast beam adjustment and/or beam tracking.

### BRIEF DESCRIPTION OF THE DRAWINGS

Further objects, features and advantages will appear from the following detailed description of embodiments, with reference being made to the accompanying drawings. The drawings are not necessarily to scale, emphasis instead being placed upon illustrating the example embodiments.

FIG. 1A is a flowchart illustrating example method steps for a transmitter device according to some embodiments;

FIG. 1B is a flowchart illustrating example method steps for a receiver device according to some embodiments;

FIG. 1C is a signaling diagram illustrating example signaling between a transmitter device and a receiver device according to some embodiments;

FIG. 2A is a schematic drawing illustrating example measurement signal transmission;

FIG. 2B is a schematic drawing illustrating example measurement signal transmission according to some embodiments;

FIG. 3 is a flowchart illustrating example method steps for a transmitter device according to some embodiments;

FIG. 4A is a plot illustrating example overhead reductions achievable for some embodiments;

FIG. 4B is a plot illustrating example benefits of some embodiments;

FIG. 5 is a schematic block diagram illustrating an example transmitter apparatus according to some embodiments;

FIG. 6 is a schematic block diagram illustrating an example transmitter apparatus according to some embodiments; and

FIG. 7 is a schematic drawing illustrating an example computer readable medium according to some embodiments.

### DETAILED DESCRIPTION

As already mentioned above, it should be emphasized that the term “comprises/comprising” (replaceable by “includes/including”) when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Embodiments of the present disclosure will be described and exemplified more fully hereinafter with reference to the accompanying drawings. The solutions disclosed herein can, however, be realized in many different forms and should not be construed as being limited to the embodiments set forth herein.

In the following, embodiments will be described where measurement signals for beam selection are transmitted by a transmitter device and used by a receiver device to perform measurements for beam selection.

Generally, when a communication device is referred to herein it may refer to one or more of: a transmitter device, a receiver device, a radio access node (e.g., a base station—BS, an access point—AP, or similar), and a user device (e.g., a user equipment—UE, a station—STA, or similar).

Also generally, a transmitter device may refer to a radio access node (e.g., a base station—BS, an access point—AP, or similar), or a user device (e.g., a user equipment—UE, a station—STA, or similar), for example.

Also generally, a receiver device may refer to a radio access node (e.g., a base station—BS, an access point—AP, or similar), or a user device (e.g., a user equipment—UE, a station—STA, or similar), for example.

Also generally, when an apparatus (e.g., a transmitter apparatus or a receiver apparatus) is referred to herein, it may refer to a corresponding communication device, or to part of a corresponding communication device (e.g., a control circuit).

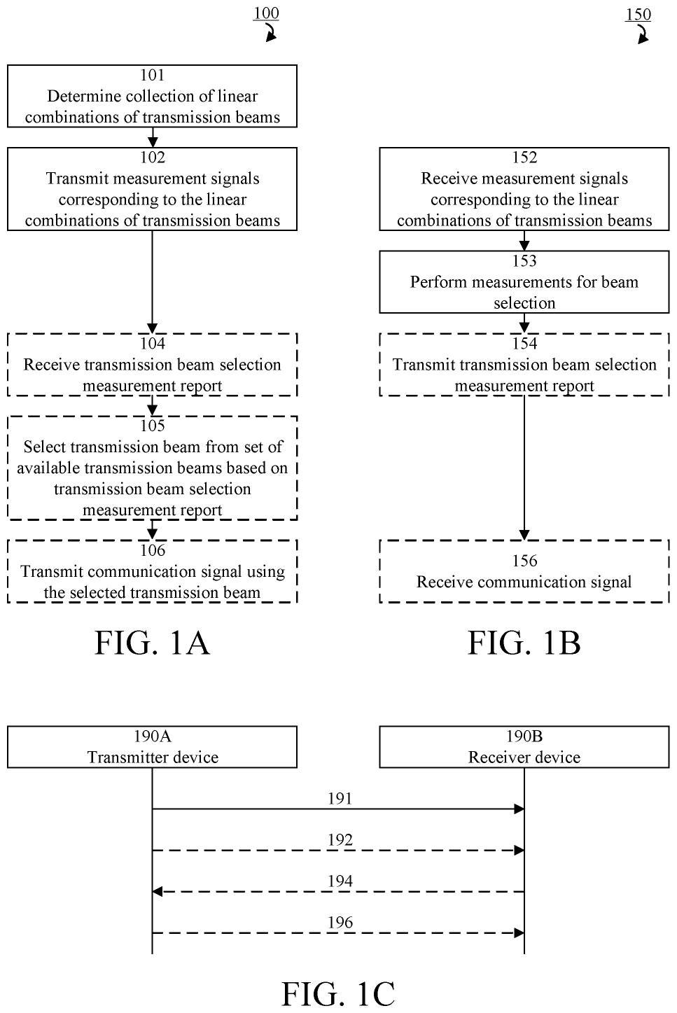

FIG. 1A illustrates an example method 100 for a transmitter device according to some embodiments, FIG. 1B illustrates an example method 150 for a receiver device according to some embodiments, and FIG. 1C illustrates example signaling between a transmitter device 190A and a receiver device 190B according to some embodiments.

FIGS. 1A, 1B , and 1C will be described in association with each other. Thus, the transmitter device 190A may perform the method 100 while the receiver device 190B performs the method 150. In some embodiments, a system comprises the transmitter device and the receiver device described in connection to FIGS. 1A, 1B, and 1C.

However, it should be noted that the teachings of any one of these Figures is not necessarily conditioned on the teachings of any other one of these Figures. For example, a transmitter device may perform the method 100 while a corresponding receiver device performs a method that is different from the method 150, and/or a receiver device may perform the method 150 while a corresponding transmitter device performs a method that is different from the method 100.

The transmitter device 190A performing the method 100 is configured for transmission of measurement signals for beam selection and the receiver device 190B performing the method 150 is configured for performing measurements for beam selection.

In step 101, the transmitter device determines a collection of linear combinations of transmission beams, wherein the transmission beams are of a set of available transmission beams. In various embodiments, the set of available transmission beams may comprise all beams that can be used for communication transmission, or a subset of all beams that can be used for communication transmission. For example, the set of available transmission beams may be a subset spanning the beam space of all beams that can be used for communication transmission (e.g., the set of available transmission beams may consist of a minimum number of transmission beams spanning the beam space of all beams that can be used for communication transmission).

Generally, transmission beams may comprise any suitable beams. Examples include discrete Fourier transform, DFT, beams, wherein a beam direction of a DFT beam may correspond to a harmonic spatial frequency, for example.

In step 102, the transmitter device transmits measurement signals to the receiver device, wherein each of the measurement signals corresponds to a linear combination of transmission beams from the collection of linear combinations of transmission beams. Thus, a linear combination of transmission beams represents the transmission beams that are sounded with the same measurement signal. The measurement signals are illustrated by 191 and are received by the receiver device in step 152.

In some embodiments, the set of available transmission beams is split into two or more subsets of available transmission beams, and separate collections of linear combinations of transmission beams are determined for each of the subsets in step 101. This is exemplified in FIG. 1C by further measurement signals 192, wherein 191 represents measurement signals for a first subset of available transmission beams and 192 represents measurement signals for a second subset of available transmission beams.

In step 153, the receiver device performs measurements for beam selection on the measurement signals. The measurements of step 153 are for selection of a transmission beam from the set of available transmission beams.

The selection of a transmission beam from the set of available transmission beams is based on the measurements for beam selection. The selection may be performed by the receiver device, or by the transmitter device, or by another device (e.g., a centralized and/or cloud-based control node).

In optional step 154, the receiver device transmits a transmission beam selection measurement report to the transmitter device. The transmission beam selection measurement report is illustrated by 194 and is received by the transmitter device in optional step 104.

In optional step 105, the transmitter device selects a transmission beam from the set of available transmission beams in accordance with the received transmission beam selection measurement report.

When the receiver device performs selection of a transmission beam, the transmission beam selection measurement report may comprise an indication of the selected beam (e.g., a beam index), and step 105 may comprise selecting the transmission beam indicated by the transmission beam selection measurement report.

When the receiver device performs determination of one or more preferable transmission beams, the transmission beam selection measurement report may comprise an indication of the preferable transmission beams (e.g., beam indices), and step 105 may comprise selecting one of the preferable transmission beams indicated by the transmission beam selection measurement report.

When the transmitter device performs selection of the transmission beam, the transmission beam selection measurement report may comprise results of the measurements performed in step 153, and step 105 may comprise selecting the transmission beam based on the measurement results of the transmission beam selection measurement report.

In optional step 106, the transmitter device transmits a communication signal to the receiver device using the selected transmission beam. The communication signal is illustrated by 196 and is received by the receiver device in optional step 156. For example, the communication signal may be a signal carrying data (e.g., a physical downlink shared channel, PDSCH) or control information (e.g., a physical downlink control channel, PDCCH) to the receiver device.

Turning to the determination of the collection of linear combinations of transmission beams in step 101, a cardinality, R, of the collection of linear combinations of transmission beams is lower than a cardinality, N, of the set of available transmission beams. Thus, N available transmission beams are organized into R linear combinations, and R measurement signals are transmitted using R radio resources in step 102 to achieve sounding for N beams. Thereby, less radio resources are needed than for traditional beam sounding.

Each transmission beam in the set of available transmission beams is comprised in at least one linear combination of transmission beams. Thus, all N available transmission beams are sounded; each in at least one measurement signal (i.e., each using at least one radio resource).

Furthermore, at least one (e.g., one, some, all but one, or all) of the linear combinations of transmission beams comprises less than all transmission beams of the set of available transmission beams. Thus, at least one of the measurement signal does not comprise the entire set of available transmission beams (i.e., at least one radio resource does not sound the entire set of available transmission beams). In some embodiments, none of the linear combinations of transmission beams comprises all transmission beams of the set of available transmission beams.

In some embodiments, it may be preferable to keep the number of transmission beams in each linear combination below an upper limit. For example, the upper limit may correspond to a number of transceiver chains of a hybrid, or analog, beamforming architecture of the transmitter device.

In some embodiments, each of the linear combinations of transmission beams of the collection of linear combinations of transmission beams is a unique linear combination.

Step 101 may comprise determining the cardinality, R, of the collection of linear combinations of transmission beams based on the cardinality, N, of the set of available transmission beams in some embodiments. For example, the cardinality, R, of the collection of linear combinations of transmission beams may be determined as the lowest R that satisfies N≤2^{R}−1. Thus, in these embodiments, R measurements signals (i.e., R radio resources) suffices to sound N transmission beams if N∈[2^{R-1}, . . . , 2^{R}−1].

In some embodiments, determining the collection of linear combinations of transmission beams in step 101 comprises iterating for l=1, . . . ,L, wherein L≤R is the highest L that satisfies

$${\sum }_{n = 1}^{L} ( \begin{matrix}R \\ n\end{matrix} ) \leq N :$$

selecting an l^{th} group of

$$( \begin{matrix}R \\ l\end{matrix} )$$

transmission beams from the set of N available transmission beams,
letting each transmission beam of the l^{th} group be comprised in exactly l of the linear combinations, and
letting each linear combination comprise exactly

$$( \begin{matrix}R - 1 \\ l - 1\end{matrix} )$$

transmission beams of the l^{th} group.
   When N=2^{R}−1, the iteration ends with l=R. When N<2^{R}−1, the iteration continues with:
selecting an (L+1)^{th} group of less than

$$( \begin{matrix}R \\ L\end{matrix} )$$

transmission beams from the set of N available transmission beams,
letting each transmission beam of the (L+1)^{th} group be comprised in exactly (L+1) of the linear combinations, and
letting each linear combination comprise at most

$$( \begin{matrix}R - 1 \\ L\end{matrix} )$$

transmission beams of the (L+1)^{th} group.

Typically, each transmission beam in the set of available transmission beams is comprised in exactly one group. This may be accomplished by removing, after each iteration, the transmission beams selected for a group such that they are not possible to select for subsequent iterations.

In some embodiments, the method 100 may further comprise (e.g., as part of any of steps 101 and 102) allocating, for each linear combination of transmission beams, a respective transmission power for each transmission beam of the set of available transmission beams that is comprised in the linear combination of transmission beams.

For example, the respective transmission powers may be allocated such that a sum over the collection of linear combinations of transmission beams of the respective transmission powers allocated for a transmission beam is equal for all transmission beams of the set of available transmission beams. Thus, all transmission beams are allocated the same power when accumulating all measurement signals (or when accumulating all linear combinations of transmission beams). One possibility is to spread the allocated power for a transmission beam uniformly over the linear combinations that comprise the transmission beam. Thus, the respective transmission power for a transmission beam may be inversely proportional to a number of linear combinations that the transmission beam is comprised in.

As already mentioned, step 102 may comprise transmitting each measurement signal using a respective radio resource. For example, transmitting the measurement signals may comprise transmitting (for each of the linear combinations of transmission beams of the collection of linear combinations of transmission beams) a measurement signal that corresponds to the linear combination of transmission beams in a respective transmission time resource (wherein at least some of the respective time resources are different) and/or in a respective transmission frequency resource (wherein at least some of the respective frequency resources are different).

Performing measurements for beam selection in step 153 may comprise determining a quality metric for each transmission beam of the set of available transmission beams. For example, the quality metric for a transmission beam may be the average received power for measurement signals sounding that transmission beam. Alternatively or additionally, performing measurements for beam selection comprises subjecting the received measurement signals to matched filtering based on the collection of linear combinations of transmission beams to determine the quality metric.

Whether performed by the transmitter device or by the receiver device, selecting the (preferred) transmission beam may comprise selecting a transmission beam that has a most preferred quality metric. For example, when step 153 comprises determining, for each transmission beam in the set of available transmission beams, an average received power over all measurement signals that correspond to linear combinations comprising the transmission beam, the selection may comprise selecting a transmission beam that corresponds to a highest average received power.

At least some of the steps described above (e.g., one or more of 101, 102, 152, 153, 154, 104, and 105) may be applied during a training phase for beam selection.

Approaches described herein may be particularly suitable for a transmitter device configured to transmit by analog, or hybrid, beamforming. This is because such a transmitter device has a limited number of transceiver chains (compared to the number of antenna elements) and can sound at most a corresponding number of transmission beams in the same radio resource (e.g., at the same time). Thus, reducing the signaling overhead caused by beam sounding in these transmitter devices is constrained in that the number of transmission beams sounded by a single measurement signal cannot exceed the number of transceiver chains. Alternatively or additionally, approaches described herein may be used for a transmitter device configured to transmit by digital beamforming.

Furthermore, approaches described herein may be particularly suitable for high frequency scenarios. This is because in such scenarios, the number of available beams may be relatively high so that a traditional beam sweep may entail particularly large training overhead. However, approaches described herein may generally be used for any scenario regardless of the carrier frequency.

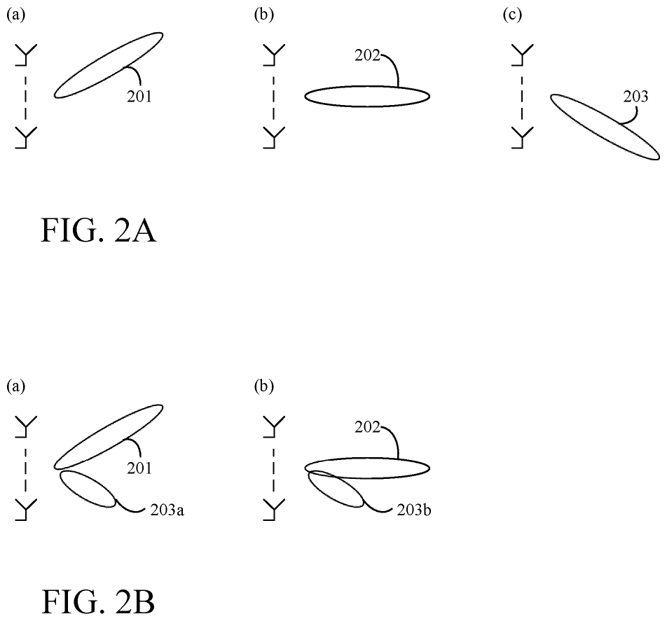

Some exemplification illustrating various contexts and details of some embodiments will now be presented with reference to FIGS. 2A, 2B, 3, 4A and 4B.

In wireless communication standards that rely on beamforming (e.g., third generation partnership project (3GPP) new radio (NR)—for example release 15 and/or 16, and IEEE 802.11 ay), the radio access node (e.g., BS or AP) typically applies a procedure for finding, or refining, a suitable (e.g., the best) beam towards the user device (e.g., UE or STA) that it serves.

One traditional way of implementing this procedure is that the radio access node consecutively transmits (narrow) orthogonal beams (e.g. DFT beams) one-by-one, and that the used device performs measurements to estimate the quality of the resulting downlink channel for each of the beams.

Using a DFT-like grid-of-beams may be suitable since many multi-antenna wireless channels can be modelled as a sum of DFT-like paths at certain angles. Thus, by matching the structure of the beams to the structure of the paths that constitute the channel, it may be expected that some beams will be well aligned with some paths (hopefully the strongest path) of the channel.

From the estimates, the user device may determine the best beam and feed an indication thereof back to the radio access node. Alternatively, the user device may feed an indication of the estimates back to the radio access node, and the radio access node may determine the best beam. This procedure is commonly referred to as beam sweeping.

This mechanism has been utilized in, e.g., IEEE 802.11ac and works well if the radio access node (e.g., an AP) has relatively few antenna elements. However, the number of orthogonal beams that need to be transmitted typically increases with the number of antenna elements at the radio access node. Therefore, the above mechanism may be unsuitable for situations with relatively many antenna elements at the radio access node. Potential examples may relate to future NR releases (e.g., release 17 and beyond) and/or sixth generation (6G) 3GPP systems operating at high carrier frequencies (e.g., THz and/or mmWave), where the radio access node will typically be equipped with many antenna elements in order to overcome relatively high channel path loss. Thus, traditional beam sweeping methods may be unsuitable, since the signaling overhead for training scales with the number of beams that need to be sounded.

Beam adjustment (or beam tracking) procedures where—instead of sounding the entire codebook—only a subset of transmission beams are tested entails similar challenges.

Thus, traditional training procedures for beam selection in which a large number of candidate transmitter beams are sounded one-by-one results in using a correspondingly large number of radio resources, which contributes to the signaling overhead for beam training. If the matrix F denotes the original codebook with all narrow beams of interest (i.e., the set of available transmission beams; e.g., DFT beams) represented in its columns, the number of columns equals the number of radio resources needed for traditional sounding.

Hence, it would be desirable to have procedures that can reduce the signaling overhead for beam sounding; preferably while maintaining (or at least not substantially degrade) the beam selection performance.

Techniques for achieving this purpose will be exemplified in the following. These techniques aim to find a suitable (e.g., the best) beam while entailing lower signaling overhead for beam training compared to a traditional beam sweep by substituting (for sounding) the original grid-of-beams codebook represented by the matrix F by another codebook represented by the matrix C=FW having less columns than F, thereby yielding lower signaling overhead. The matrix W may be seen as implementing a weighting function.

The weighting matrix W is tall, which ensures that the number of columns of C is smaller than the number of columns in F. As a consequence, less radio resources are needed when sounding the columns of C, that when sounding the columns of F.

The N columns of F represent the set of available transmission beams. Each column of C represents a linear combination of the transmission beams represented by the columns of F. Thus, the R columns of C represent a collection of linear combinations of available transmission beams.

Then, beam selection comprises finding a suitable (e.g., the best) beam represented by a column of F based on received sounding signals representing beams of C. Thus, the matrix C should preserve some information regarding the columns of F, which puts requirements on the weighting function represented by W. For example, a column of F may contribute to multiple columns of C, according to the structure of W.

It may be desirable that at least some (e.g., each) of the columns of W are sparse (e.g., comprising at least some zero-valued entries; possibly defined by a threshold value), thereby, in practice, keeping the number of transmission beams in the corresponding linear combination below an upper limit. This may be particularly relevant for hybrid, or analog, transmitter architectures as explained above.

Alternatively or additionally, it may be desirable that at least some (e.g., all) of the rows of W yield the same L2 norm, representing the same power scaling, thereby giving the corresponding transmission beams the same weighting in the sounding procedure. Alternatively or additionally, if one, or some, transmission beams are more likely to be suitable than other transmission beams, the more likely beams may be given higher weighting according to some embodiments. The latter may be particular suitable for beam tracking.

Generally, the values of the non-zero elements of W controls the beam selection. For example, it may be suitable that all non-zero valued entries of a row of W has the same value since this approach can maximize the probability of properly selecting the transmission beam.

As already mentioned, some approaches presented herein are suitable to be implemented in hybrid array architectures (i.e., architectures with less transceiver chains than antenna elements). This is because the number of simultaneously sounded beams is kept low, which means that each transceiver chain and the associated set of phase shifters (e.g., each analog beamformer) can realize a respective one of the simultaneously sounded DFT beams. Furthermore, each antenna element then transmits with peak power, since different simultaneously sounded DFT beams are realized by different analog beamformers. This may be beneficial for maximizing coverage and/or for maximizing power amplifier efficiency.

The codebook construction illustrated by the following examples may achieve minimum sounding overhead while having a solvable (i.e., identifiable) beam detection problem. For example, in traditional beam sweeping N radio resources are needed to sound N transmission beams, while in the following examples, only R radio resources are needed to sound N transmission beams, where log₂(N+1)≤R≤1+log₂(N).

It should be noted that, even though the transmitter device may be a BS and the receiver device may be a UE in typical examples referred to herein, other possible setups are not excluded (e.g., uplink beam training when the UE is the transmitter device and the BS is the receiver device, an Integrated Access and Backhaul (IAB) beam training where the transmitter device is a BS and the receiver device is another BS, etc.).

FIGS. 2A and 2B schematically illustrate example measurement signal transmission using an example where the set of available transmission beams has cardinality N=3.

FIG. 2A shows a traditional beam sweeping approach where each available transmission beam 201, 202, 203 is sounded by transmission of a respective measurement signal in a respective one of 3 radio resources; the three transmissions represented by the three parts of FIG. 2A; (a), (b) and (c).

This may be seen as using a matrix W that is an identity matrix, and each received measurement signal is associated with one, and only one, transmission beam. Assuming that samples representing the three received measurement signals may be collected in a column vector y=[y₁y₂y₃]^{T}, the signal model may be expressed as y=hFW=hF, where h is a row vector representing a narrowband multiple-input single-output (MISO) propagation channel, and the detection rule may be to select beam k when |yₖ|²≥|yₙ|², ∀n≠k.

FIG. 2B shows a beam sweeping approach according to some embodiments, where a first available transmission beam 201 is sounded in a first radio resource, a second available transmission beam 202 is sounded in a second radio resource, and a third available transmission beam is sounded in both of the first and second radio resources as illustrated by 203a, 203b. The measurement signal transmitted in the first radio resource (represented by part (a) of FIG. 2B) comprises the first available transmission beam 201 as well as the third available transmission beam 203a, and the measurement signal transmitted in the second radio resource (represented by part (b) of FIG. 2B) comprises the second available transmission beam 202 as well as the third available transmission beam 203b.

It should be noted that no third radio resource is needed, i.e., a signaling overhead reduction of 33% compared to traditional beam sweeping.

The third available transmission beam 203a, 203b has a lower power in each radio resource than the first and second available transmission beam, while the total power over all radio resources may be equal for all available transmission beams. This may be realized by using, for example, a matrix

$$W = [ \begin{matrix}1 & 0 \\ 0 & 1 \\ 1 / \sqrt{2} & 1 / \sqrt{2}\end{matrix} ] .$$

Each received measurement signal, one per radio resource, is then associated with two transmission beams. Assuming that samples representing the two received measurement signals may be collected in a column vector y=[y₁y₂]^{T}, the signal model may be expressed as y=hFW, where h is a row vector representing the narrowband MISO propagation channel.

Assuming that the channel is time-invariant across the two radio resources (to enable coherent processing of the two received signals) and that the channel is sparse, a suitable detection rule may be (e.g., in accordance with a Generalized Likelihood Ratio Test (GRLT)) to:
select the first beam 201 when the power received in the first radio resource is higher than the power received in the second radio resource and higher than the average power received in the first and second radio resources, i.e., when |y₁|²>|y₂|² and

$${\vert {y}_{1} \vert}^{2} > {\vert \frac{( {y}_{1} + {y}_{2} )}{2} \vert}^{2} ,$$

select the second beam 202 when the power received in the second radio resource is higher than the power received in the first radio resource and higher than the average power received in the first and second radio resources, i.e., when |y₂|² >|y₁|² and

$${\vert {y}_{2} \vert}^{2} > {\vert \frac{( {y}_{1} + {y}_{2} )}{2} \vert}^{2} ,$$

and
select the third beam 203a, 203b when the average power received in the first and second radio resources is higher than the power received in the first radio resource and higher than the power received in the second radio resource, i.e., when

$${\vert \frac{( {y}_{1} + {y}_{2} )}{2} \vert}^{2} > {\vert {y}_{1} \vert}^{2} and {\vert \frac{( {y}_{1} + {y}_{2} )}{2} \vert}^{2} > {\vert {y}_{2} \vert}^{2} .$$

Before generalizing the principles of FIG. 2B to higher values of N, some further remarks will be given, which are generally applicable even if given in the context of FIG. 2B.

A first remark concerns beam energy re-scaling. In FIG. 2B, all three transmission beams were allocated equal power when summed over the full sounding procedure (all radio resources). This may be suitable when no prior knowledge is at hand, and/or when a criterion of fairness between transmission beams is applied. However, in some embodiments, the power allocated to some transmission beam(s) may be re-scaled (by using re-scaled entry values for the corresponding row(s) of W). This may be suitable when prior knowledge is at hand; e.g., interference estimates and/or link budget estimates for the link(s) associated with the transmission beams(s).

A second remark concerns realizations of the sounding codebook in hybrid arrays, with some different examples for realizing the sounding procedure in hybrid antenna array systems.

A first realization is in a 2-port hybrid array made of dual-polarized antenna elements, where the first antenna port is associated with all antenna elements of one polarization (e.g., vertical polarization) and the second port is associated with all antenna elements of another polarization (e.g., horizontal polarization). Then, beam 201 and 202 in FIG. 2B may be realized using one polarization, and beam 203a, 203b may be realized using the other polarization. Preferably a beam transmitted in several radio resources should use the same polarization for all radio resources; for reasons of transmission phase consistency, which is important for coherent processing of the received signals. After selection of a transmission beam, the transmitter device may tune the phase shifters associated both polarizations towards the direction of the selected beam. This realization enables only two transmission beams per radio resource (since there are two polarizations), but potentially enables use of relatively narrow beams.

A second realization is in an architecture comprising an array of sub-arrays, where each transmission beam of a radio resource may be realized by a respective sub-array (possibly using both polarizations simultaneously). This realization enables as many transmission beams per radio resource as there are sub-arrays, but potentially enables use of only relatively wide beams (since the aperture of each sub-array is smaller than the aperture of the entire array).

A third realization is a combination of the first and second realizations, where each transmission beam of a radio resource may be realized by a respective sub-array and a respective polarization. This realization provides higher flexibility than the first and second realizations in terms of the number of transmission beams per radio resource and/or in terms of beam width.

The example of FIG. 2A (with N=3 and R=2) will now be generalized to arbitrary values of N, and it will be illustrated that R radio resources suffices to sound N=2^{R}−1 transmission beams. A systematic construction of corresponding codebooks will be illustrated, which can be implemented, e.g., by filling in a table where each column is associated with a radio resource. The resulting codebooks may achieve a maximum overhead reduction compared with the traditional approach for sounding a given number of transmission beams, and/or may maximize the probability to identify the dominant transmission beam.

### 3 Beams in 2 Resources

The codebook of the example of FIG. 2B may be represented in the form of the following table:

| | Radio resource | | |
|---|---|---|---|
| | 1 | 2 | Number of beams |
| Beam index | 1 | 2 | $( \begin{matrix}2 \\ 1\end{matrix} )$ |
| | 3 | 3 | $( \begin{matrix}2 \\ 2\end{matrix} )$ |

The first row corresponds to transmission beams conveyed in only one radio resource (compare with 201, 202 of FIG. 2B) and the second row corresponds to transmission beams conveyed in both radio resource (compare with 203a, 203b of FIG. 2B). The first column corresponds to transmission beams conveyed in the first radio resource (compare with 201, 203a of FIG. 2B) and the second column corresponds to transmission beams conveyed in the second radio resource (compare with 202, 203b of FIG. 2B).

It may be noted that the number of beams in each row of the table corresponds to a respective entry of the 2^{nd} row of Pascal's triangle (i.e., the second entry of the second row in Pascal's triangle for the first row of the table, and the third entry of the second row in Pascal's triangle for the second row of the table). The first entry of the second row in Pascal's triangle corresponds to transmission beams sounded zero times, and is therefore irrelevant.

It may also be noted that the total number of sounded beams is

$${\sum }_{n = 1}^{2} ( \begin{matrix}2 \\ n\end{matrix} ) = ( \begin{matrix}2 \\ 1\end{matrix} ) + ( \begin{matrix}2 \\ 2\end{matrix} ) = {2}^{2} - 1 = 3 .$$

Thus, it may be concluded that the maximum number of beams that can be sounded in 2 resources (while enabling beam identification based on the measurement signals) is 3, since this exploits all possible beam combinations, and the maximum overhead reduction compared to traditional beam sweeping becomes (3−2)/3=0.33.

### 7 Beams in 3 Resources

Generalizing the above example to three radio resources, a codebook may be represented in the form of the following table:

| | Radio resource | | | |
|---|---|---|---|---|
| | 1 | 2 | 3 | Number of beams |
| Beam index | 1 | 2 | 3 | $( \begin{matrix}3 \\ 1\end{matrix} )$ |
| | 4,6 | 4,5 | 5,6 | $( \begin{matrix}3 \\ 2\end{matrix} )$ |
| | 7 | 7 | 7 | $( \begin{matrix}3 \\ 3\end{matrix} )$ |

The first row corresponds to transmission beams conveyed in only one radio resource, the second row corresponds to transmission beams conveyed in two radio resources, and the third row corresponds to transmission beams conveyed in all three radio resources. The first column corresponds to transmission beams conveyed in the first radio resource, the second column corresponds to transmission beams conveyed in the second radio resource, and the third column corresponds to transmission beams conveyed in the third radio resource.

It may be noted that the number of beams in each row of the table corresponds to a respective entry of the 3^{rd} row of Pascal's triangle (i.e., the second entry of the third row in Pascal's triangle for the first row of the table, the third entry of the third row in Pascal's triangle for the second row of the table, and the fourth entry of the third row in Pascal's triangle for the second third of the table). As above, the first entry in Pascal's triangle corresponds to transmission beams sounded zero times and is therefore irrelevant.

It may also be noted that the total number of sounded beams is

$${\sum }_{n = 1}^{3} ( \begin{matrix}3 \\ n\end{matrix} ) = ( \begin{matrix}3 \\ 1\end{matrix} ) + ( \begin{matrix}3 \\ 2\end{matrix} ) + ( \begin{matrix}3 \\ 3\end{matrix} ) = {2}^{3} - 1 = 7 .$$

Thus, it may be concluded that the maximum number of beams that can be sounded in 3 resources (while enabling beam identification based on the measurement signals) is 7, since this exploits all possible beam combinations, and the maximum overhead reduction compared to traditional beam sweeping becomes (7−3)/7=0.57.

One possible matrix W that realizes this example codebook construction (and assigns equal power per beam over the entire sounding procedure) may be:

$$W = [ \begin{matrix}1 & 0 & 0 \\ 0 & 1 & 0 \\ 0 & 0 & 1 \\ 1 / \sqrt{2} & 1 / \sqrt{2} & 0 \\ 0 & 1 / \sqrt{2} & 1 / \sqrt{2} \\ 1 / \sqrt{2} & 0 & 1 / \sqrt{2} \\ 1 / \sqrt{3} & 1 / \sqrt{3} & 1 / \sqrt{3}\end{matrix} ] .$$

### 15 Beams in 4 Resources

Generalizing the above examples to four radio resources, a codebook may be represented in the form of the following table:

| | Radio resource | | | | |
|---|---|---|---|---|---|
| | 1 | 2 | 3 | 4 | Number of beams |
| Beam index | 1 | 2 | 3 | 4 | $( \begin{matrix}4 \\ 1\end{matrix} )$ |
| | 5,6,7 | 5,8,9 | 6,8,10 | 7,9,10 | $( \begin{matrix}4 \\ 2\end{matrix} )$ |
| | 11,12,13 | 11,12,14 | 11,13,14 | 12,13,14 | $( \begin{matrix}4 \\ 3\end{matrix} )$ |
| | 15 | 15 | 15 | 15 | $( \begin{matrix}4 \\ 4\end{matrix} )$ |

The first row corresponds to transmission beams conveyed in only one radio resource, the second row corresponds to transmission beams conveyed in two radio resources, the third row corresponds to transmission beams conveyed in three radio resources, and the fourth row corresponds to transmission beams conveyed in all four radio resources. The first column corresponds to transmission beams conveyed in the first radio resource, the second column corresponds to transmission beams conveyed in the second radio resource, the third column corresponds to transmission beams conveyed in the third radio resource, and the fourth column corresponds to transmission beams conveyed in the fourth radio resource.

It may be noted that the number of beams in each row of the table corresponds to a respective entry of the 4^{th} row of Pascal's triangle. As above, the first entry of the fourth row in Pascal's triangle corresponds to transmission beams sounded zero times and is therefore irrelevant.

It may also be noted that the total number of sounded beams is

$${\sum }_{n = 1}^{4} ( \begin{matrix}4 \\ n\end{matrix} ) = {2}^{4} - 1 = 15 .$$

Thus, it may be concluded that the maximum number of beams that can be sounded in 4 resources (while enabling beam identification based on the measurement signals) is 15, since this exploits all possible beam combinations, and the maximum overhead reduction compared to traditional beam sweeping becomes (15−4)/15=0.73.

### N Beams in R Resources

Generalizing the above examples to R radio resources, a codebook may be represented in the form of a table wherein the first row corresponds to transmission beams conveyed in only one radio resource, the second row corresponds to transmission beams conveyed in two radio resources, etc., and wherein the first column corresponds to transmission beams conveyed in the first radio resource, the second column corresponds to transmission beams conveyed in the second radio resource, etc.

The number of beams in each row of the table corresponds to a respective entry of the R^{th} row of Pascal's triangle (the first entry of that row in Pascal's triangle corresponds to transmission beams sounded zero times and is therefore irrelevant), and the total number of sounded beams is

$${\sum }_{n = 1}^{R} ( \begin{matrix}R \\ n\end{matrix} ) = {2}^{R} - 1 .$$

Thus, it may be concluded that the maximum number of beams that can be sounded in R resources (while enabling beam identification based on the measurement signals) is 2^{R}−1, since this exploits all possible beam combinations, and the maximum overhead reduction compared to traditional beam sweeping becomes (2^{R}−1−R)/(2^{R}−1).

Generally, the construction for codebooks for 2^{R}−1 beams, can be systematically achieved by filling in the rows of a table one by one, where a beam is only present on one row, the n^{th} row comprises combinations of a group of n beams, each entry of the nth row comprises a unique combination of beams form the group of n beams, and each beam of the group of n beams occurs in exactly n entries.

The respective transmission power for a transmission beam may be inversely proportional to a number of linear combinations that the transmission beam is comprised in, i.e., corresponding to an entry value of 1/\sqrt{n} in W.

The number N of transmission beams to be sounded may not necessarily be expressible in terms of 2^{R}−1, where R is an integer. Generally, the number of radio resources needed for sounding of N transmission beams (while enabling beam identification based on the measurement signals) is the lowest R that satisfies N≤2^{R}−1. Put differently, at least R radio resources are suitable to sound N transmission beams (while enabling beam identification based on the measurement signals) when N∈[2^{R-1}, . . . , 2^{R}−1].

One example of how to construct a codebook for the general case may be represented in the form of a table with R columns and R rows, similar to what has been illustrated above; where the last row is left empty if N=2^{R}−2, where the last row and a beam position of the second to last row are left empty if N=2^{R}−3, where the last row and two beam positions of the second to last row are left empty if N=2^{R}−4, etc. Of course, other variations may be envisioned (e.g., where beam position(s) of row n may be left empty even when there are un-empty beam position(s) on row n+1).

The overhead reduction compared to traditional beam sweeping generally is (N−R)/N. Also generally, the number of beams that can be sounded in each of R radio resources is 2^{(R-1)}.

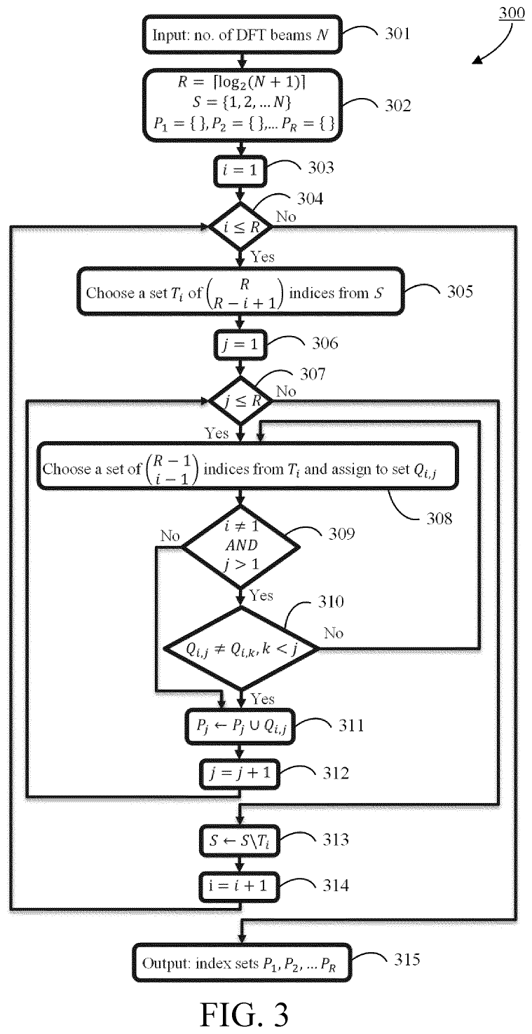

FIG. 3 illustrates an example method 300 for a transmitter device according to some embodiments. For example, the method 300 may be performed as part of step 101 of FIG. 1A.

The method 300 may be seen as a codebook construction algorithm; i.e., as a way to determine the collection of linear combinations of transmission beams.

In step 301, the method 300 receives as an input the number N of transmission beams (e.g., DFT beams) in the set of available transmission beams.

In step 302, the number R of resources required to sound the N of transmission beams is determined as R=[log₂(N+1)]; i.e., the lowest R that satisfies N≤2^{R}−1. The set of available transmission beams is indexed in a set S={1, 2, . . . , N}, and an empty set is created for each of the R resources; Pᵣ={ }, r=1, 2, . . . , R.

A counter i is initiated to one in step 303, and while i≤R (Yes-path out of step 304), the method 300 proceeds to step 305. The counter i represents which row of the codebook table (compare with the example tables above) the method 300 is currently processing. It should be noted that execution of the method 300 may be seen as a way to fill the previously presented tables starting with the last row.

In step 305, a set Tᵢ is chosen from S. The set Tᵢ represents the transmission beams that will be distributed on the currently processed row of the codebook table. The cardinality of the set Tᵢ represents the number of transmission beams on the currently processed row and equals

$$( \begin{matrix}R \\ R - i + 1\end{matrix} ) ;$$

unless there are fewer members in the set S, in which case Tᵢ=S.

A counter j is initiated to one in step 306, and while j≥R (Yes-path out of step 307), the method 300 proceeds to step 308. The counter j represents which column entry of the currently processed row of the codebook table the method 300 is currently processing.

In step 308, a set Q_{i,j} is chosen from Tᵢ . The set Q_{i,j} represents the transmission beams that will appear in the entry of row i and column j of the codebook table. The cardinality of the set Q_{i,j} represents the number of transmission beams in the currently processed entry of the codebook table and equals

$$( \begin{matrix}R - 1 \\ i - 1\end{matrix} ) .$$

When the set S has less than

$$( \begin{matrix}R \\ R - i + 1\end{matrix} )$$

members, the set Tᵢ can be filled up with dummy members in step 305 for proper implementation of step 308. The dummy members are then disregarded in step 315.

When i=1 and/or i=1 (No-path out of step 309), the method 300 proceeds directly to step 311. When i≠1 and i>1 (Yes-path out of step 309), the method 300 first proceeds to step 310, where it is checked whether the set Q_{i,j} differs from all other sets Q_{i,k} that have already been determined for the currently processed row; i.e., whether Q_{i,j}≠Q_{i,k}, ∀k<j. When Q_{i,j}≠Q_{i,k}, ∀k<j (Yes-path out of step 310), the method 300 proceeds to step 311. Otherwise (No-path out of step 310), another set Q_{i,j} is chosen as illustrated by the loopback to step 308. In some embodiments, there may be a mechanism whereby the probability of choosing any possible set Q_{i,j} approaches one as the number of loopbacks increases. This is one way of avoiding that the process gets stuck in the loopback. For example, step 308 may be implemented by letting the indices defining the set Q_{i,j} be randomly (or pseudo-randomly) drawn without replacement.

In step 311, the set Q_{i,j} is included in Pⱼ; i.e., Pⱼ←Pⱼ∪Q_{i,j}. Then the counter j is incremented in step 312, and the method 300 loops back to step 307.

When the last column of the currently processed row has been processed so that j=R+1 (No-path out of step 307), the method 300 proceeds to step 313.

In step 313, the set Tᵢ is removed from S; i.e., S ←S\Tᵢ . Then the counter i is incremented in step 314, and the method 300 loops back to step 304.

When the last row has been processed so that i=R+1 (No-path out of step 304), the method 300 proceeds to step 315. Even though not illustrated in FIG. 3, the method 300 may also proceed to step 315 when the set S is empty.

In step 315, the method 300 outputs the sets P₁, P₂, . . . , P_{R}, each of which indexes which transmission beams are to be sounded in the corresponding resource. Indices appearing in the set Pⱼ indicate which rows of the j^{th} column of W have non-zero entries. The sets P₁, P₂, . . . , P_{R} represents the collection of linear combinations of transmission beams, wherein each set represents one linear combination.

The use of dummy members to handle situations when N≤2^{R}−1 may be implemented as indicated above. An alternative is to fill up the set S with dummy members in step 302 so that the cardinality of S becomes 2^{R}−1, and remove the dummy members from the sets P₁, P₂, . . . , P_{R} in step 315.

The method 300 may be compared with the iteration example presented in connection with FIG. 1A. It should be noted that the iteration example presented in connection with FIG. 1A may be seen as a way to fill the previously presented tables starting from the first (top) row.

The iteration for l=1, . . . , L of the iteration example presented in connection with FIG. 1A may correspond, in reverse order, to the iteration caused by the counter i in the method 300. In the iteration example presented in connection with FIG. 1A, L=R represents the last row of the previously presented tables when N=2^{R}−1. When N≤2^{R}−1, L≤R represents the last row with filled-up entries.

Selecting an l^{th} group of

$$( \begin{matrix}R \\ l\end{matrix} )$$

transmission beams from the set of N available transmission beams may be compared to step 305.

Letting each transmission beam of the l^{th} group be comprised in exactly l of the linear combinations, and letting each linear combination comprise exactly

$$( \begin{matrix}R - 1 \\ i - 1\end{matrix} )$$

transmission beams of the l^{th} group may correspond to steps 308, 309, and 310.

Allocating respective transmission powers for each resource (i.e., for each linear combination of transmission beams) and for each transmission beam may correspond to setting the values of the non-zero valued entries of W.

As already mentioned in connection with FIG. 1C, the set of available transmission beams may be split into two or more subsets of available transmission beams, and separate collections of linear combinations of transmission beams may be determined for each of the subsets. This may be seen as a codebook construction via sub-codebooks.

The approach where the set of available transmission beams is treated as a single set for determining a collection of linear combinations of transmission beams may enable sounding of an arbitrary number of beams, while achieving the largest possible overhead reduction. However, there may be scenarios where a trade-off is desirable between the overhead reduction and the expected amount of sparsity of the channel, in which case the approach where the set of available transmission beams is treated as two or more sub-sets for determining collections of linear combinations of transmission beams may be beneficial.

For example, sounding six beams in the radio resources would result in a 50% overhead reduction using the approach where the set of available transmission beams is treated as a single set.

An alternative codebook construction for sounding may be achieved by dividing the set of available transmission beams into non-overlapping sub-sets (i.e., no beam is present in more than one sub-set), and treating each sub-set separately for sounding. In the example with six beams, two non-overlapping sub-sets of three beams each may be created, and a codebook may be determined for each of the sub-sets separately (e.g., as exemplified above for three beams and two radio resources). Then, each of the two codebooks is sounded separately. Thus, the six beams would be sounded in four resources (two sub-sets with two radio resources each), and thus the overall overhead reduction would be 33%.

Thus, a possible drawback of the sub-set approach is that the overhead reduction is smaller than for the single set approach. However, a possible advantage of the sub-set approach is that the amount of channel sparsity needed for proper beam detection is relaxed. For example, proper beam detection for the single set approach typically requires that a specific beam dominates over the other beams (this is referred to as a sparse channel). However, proper beam detection for the sub-set approach can be achieved also if two or more beams are dominant over the other beams; as long as the dominant beams are in different sub-sets.

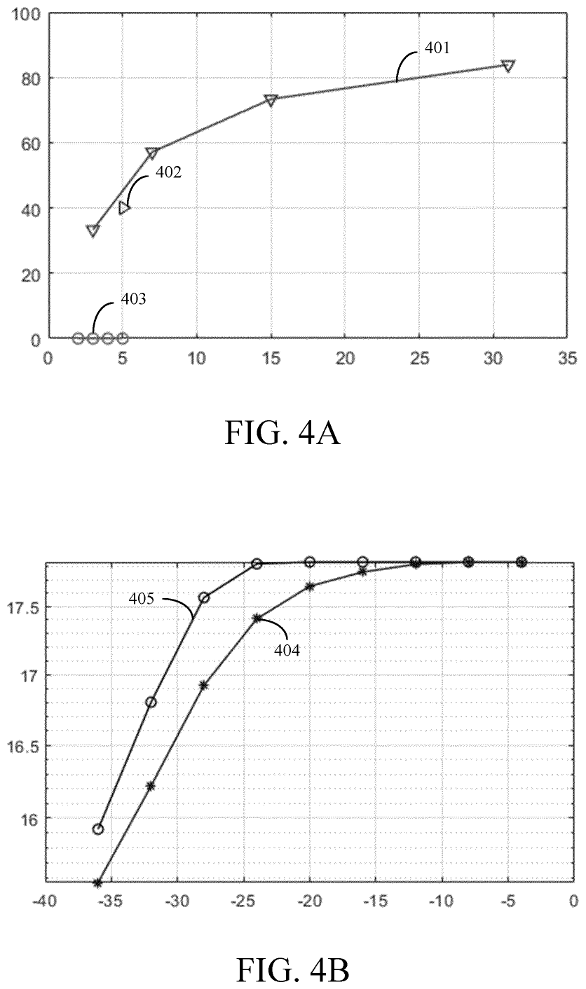

FIG. 4A illustrates example overhead reductions achievable for some embodiments. The x-axis shows the number of beams N, and the y-axis shows the overhead reduction in %.

A general expression for overhead reduction—compared to traditional beam sweeping—that is achievable by the approaches presented herein is (N−R)/N=(2^{R}−1−R)/(2^{R}−1), which converges to 1 as R→∞. This expression is illustrated by 401 in FIG. 4A, and may represent an upper bound on the overhead reduction that can be obtained with a number of radio resources, while having a solvable (i.e., identifiable) beam detection problem.

Traditional beam sweeping is illustrated by 403, which—by definition—have 0% overhead reduction, and 402 represents the overhead reduction of an example with N<2^{R}−1, where five beams are sounded in three radio resources.

FIG. 4B illustrates some example benefits of some embodiments, achieved via simulations. The x-axis shows the signal-to-noise ratio (SNR) in dB, and the y-axis shows mean effective channel gain in dB. A traditional beam sweep with three beams sounded in three radio resources is represented by 405, and an approach as proposed herein with three beams sounded in two radio resources is represented by 404.

The simulations assumed that the downlink channel h represents a narrowband multiple-input single-output (MISO) channel (e.g., a DL channel of an orthogonal frequency division multiplex (OFDM) subcarrier for a reception beam fixed during sweeping). The channel model is expressed as h=a₁e(ϕ₁)+Σᵢ₌₂³aᵢe(ϕ₁), where e_{BS}(ϕ)=[1e^{iπ sin(ϕ)} . . . e^{iπ(M-1)sin(ϕ)}] represents the steering vector across an antenna array with M=64 antenna elements from angle ϕ. The angles of departure {ϕᵢ}ᵢ₌₁^{L} are mutually independent and uniformly spread in [0, 2π]. The phases a₁, a₂ and a₃ of the complex-valued path gains are mutually independent uniform random variables in [0, 2π]. The energy of the complex-valued paths is chosen as |a₁|²=0.9, |a₂|²=0.05 and |a₃|²=0.05, which emulates a sparse channel while maintaining unit energy channels.

The original codebook is F=[e(ϕ₁)^{T}e(ϕ₂)^{T}e(ϕ₃)^{T}] in the simulations. This codebook is matched with the channel paths, and the channel setting ensures that one strong beam typically exists in every simulation run. The weighting matrix W is set to

$$W = [ \begin{matrix}1 & 0 \\ 0 & 1 \\ 1 / \sqrt{2} & 1 / \sqrt{2}\end{matrix} ] .$$

The link model is represented by y=hFW+n, where the 1×2 row vector n contains identically and independently distributed circularly-symmetric zero-mean complex-Gaussian random variable entries; each with variance σ². Since the channel entries are of unit energy, the SNR is defined as σ².

The best DFT beam, say \hat{f}, is detected from the received signals y according to the signal processing scheme described above; i.e., select the first beam when |y₁|²>|y₂|² and

$${\vert {y}_{1} \vert}^{2} > {\vert \frac{( {y}_{1} + {y}_{2} )}{2} \vert}^{2} ,$$

select the second beam when |y₂|²>|y₁|² and

$${\vert {y}_{2} \vert}^{2} > {\vert \frac{( {y}_{1} + {y}_{2} )}{2} \vert}^{2} ,$$

and select the third beam when

$${\vert \frac{( {y}_{1} + {y}_{2} )}{2} \vert}^{2} > {\vert {y}_{1} \vert}^{2} and {\vert \frac{( {y}_{1} + {y}_{2} )}{2} \vert}^{2} > {\vert {y}_{2} \vert}^{2} .$$

The simulations compare the average energy of the effective channel obtained from the inner product between the specular propagation channel h and the best chosen beam \hat{f}, namely the average “specular” channel gain E{|h\hat{f}|²}, where averaging is over all sources of randomness. Such effective channel gain is plotted against the link SNR in FIG. 4B.

For traditional beam sweeping 405, the average channel gain saturates at high SNR, which represents a situation of always choosing the best beam.

For the proposed sounding approach 404, which achieves an overhead reduction of 33.3%, there is a small performance difference (around 0.5 dB) in terms of the obtained mean effective channel gain at low SNR, and virtually no performance difference at medium to high SNR. Thus, the best beam is always chosen at high enough SNR, which also demonstrates that the beam detection problem is solvable (i.e., identifiable).

Overall, the disclosed codebook constructions may enable significant sounding overhead reductions at minimal performance degradations. Thereby, they may be good options for, e.g., beam adjustment codebooks in high Doppler channels where fast beam adjustment and/or low overhead is desirable.

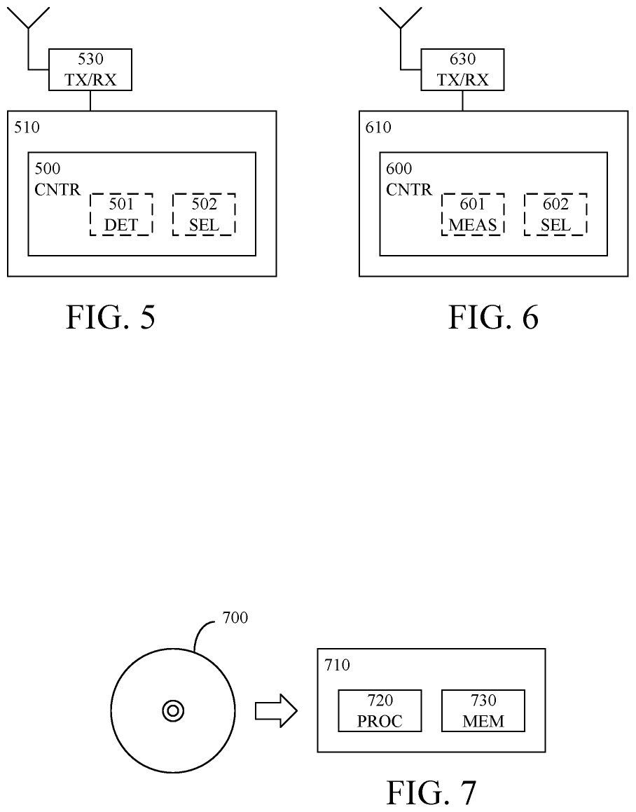

FIG. 5 schematically illustrates an example apparatus according to some embodiments. The apparatus is configured for controlling transmission of measurement signals for beam selection. Furthermore, the apparatus may be comprised, or comprisable, in a transmitter device 510 or another device. The transmitter device 510 is configured to transmit the measurement signals for beam selection.

The transmitter device 510 may, for example, correspond to any of: the transmitter device performing the method 100 of FIG. 1A, the transmitter device 190A of FIG. 1C, and the transmitter device performing the method 300 of FIG. 3. In some embodiments a radio access node or other communication device comprising the transmission device 510 may, in itself, be denoted as a transmission device.

The apparatus of FIG. 5 comprises a controller (CNTR; e.g., controlling circuitry—such as a processor—or a control module) 500.

The controller 500 is configured to cause determination of a collection of linear combinations of transmission beams (compare with 101 of FIG. 1A). To this end, the controller 500 may comprise, or be otherwise associated with (e.g., connected, or connectable, to) a determiner (DET; e.g., determining circuitry or a determination module) 501. The determiner 501 may be configured to determine the collection of linear combinations of transmission beams.

The controller 500 is also configured to cause transmission of measurement signals to a receiver device (compare with 102 of FIG. 1A). To this end, the controller 500 may comprise, or be otherwise associated with (e.g., connected, or connectable, to) a transmitter (TX; e.g., transmitting circuitry or a transmission module); illustrated in FIG. 5 as comprised in a transceiver (TX/RX) 530. The transmitter may be configured to transmit the measurement signals to the receiver device.

The controller 500 may also be configured to cause reception of a transmission beam selection measurement report from the receiver device (compare with 104 of FIG. 1A). To this end, the controller 500 may comprise, or be otherwise associated with (e.g., connected, or connectable, to) a receiver (RX; e.g., receiving circuitry or a reception module); illustrated in FIG. 5 as comprised in the transceiver (TX/RX) 530. The receiver may be configured to receive the transmission beam selection measurement report from the receiver device.

The controller 500 may also be configured to cause selection of a transmission beam from the set of available transmission beams (compare with 105 of FIG. 1A). To this end, the controller 500 may comprise, or be otherwise associated with (e.g., connected, or connectable, to) a selector (SEL; e.g., selecting circuitry or a selection module) 502. The selector 502 may be configured to select the transmission beam form the set of available transmission beams.

The controller 500 may also be configured to cause transmission of a communication signal to the receiver device using the selected transmission beam (compare with 106 of FIG. 1A). To this end, the transmitter 530 may be configured to transmit the communication signal to the receiver device.

FIG. 6 schematically illustrates an example apparatus according to some embodiments. The apparatus is configured for controlling performance of measurements for beam selection. Furthermore, the apparatus is comprised, or comprisable, in a receiver device 610. The receiver device 610 is configured to perform measurements for beam selection.

The receiver device 610 may, for example, correspond to any of: the receiver device performing the method 150 of FIG. 1B, and the receiver device 190B of FIG. 1C. In some embodiments a user equipment or other communication device comprising the receiver device 610 may, in itself, be denoted as a receiver device.

The apparatus of FIG. 6 comprises a controller (CNTR; e.g., controlling circuitry—such as a processor—or a control module) 600.

The controller 600 is configured to cause reception of measurement signals from a transmitter device (compare with 152 of FIG. 1B). To this end, the controller 600 may comprise, or be otherwise associated with (e.g., connected, or connectable, to) a receiver (RX; e.g., receiving circuitry or a reception module); illustrated in FIG. 6 as comprised in a transceiver (TX/RX) 630. The receiver may be configured to receive the measurement signals from the transmitter device.

The controller 600 is also configured to cause performance of measurements for beam selection on the measurement signals (compare with 153 of FIG. 1B). To this end, the controller 600 may comprise, or be otherwise associated with (e.g., connected, or connectable, to) a measurer (MEAS; e.g., measuring circuitry or a measurement module) 601. The measurer 601 may be configured to perform measurements for beam selection on the measurement signals.

The controller 600 may also be configured to cause selection of a transmission beam from the set of available transmission beams. To this end, the controller 600 may comprise, or be otherwise associated with (e.g., connected, or connectable, to) a selector (SEL; e.g., selecting circuitry or a selection module) 602. The selector 602 may be configured to select the transmission beam form the set of available transmission beams.

The controller 600 may also be configured to cause transmission of a transmission beam selection measurement report to the transmitter device (compare with 154 of FIG. 1B). To this end, the controller 600 may comprise, or be otherwise associated with (e.g., connected, or connectable, to) a transmitter (TX; e.g., transmitting circuitry or a transmission module); illustrated in FIG. 6 as comprised in the transceiver (TX/RX) 630. The transmitter may be configured to transmit the transmission beam selection measurement report to the transmitter device.

The controller 600 may also be configured to cause reception of a communication signal from the transmitter device (compare with 156 of FIG. 1B). To this end, the receiver 630 may be configured to receive the communication signal from the transmitter device.

It should be noted that any feature mentioned in connection with any of FIGS. 1A, 1B, 1C, and 3 may be equally applicable in the context of FIGS. 5 and/or 6, even if not explicitly mentioned in connection thereto.

It should also be noted that a communication device may be configured to operate as a transmitter device in some scenarios and as a receiver device in other scenarios. To this end, a communication device may comprise both the apparatus of FIG. 5 and the apparatus of FIG. 6.

In some embodiments, a communication system comprises a transmitter device configured for transmission of measurement signals for beam selection and a receiver device configured for performing measurements for beam selection, wherein the transmitter device comprises the apparatus of FIG. 5 and the receiver device comprises the apparatus of FIG. 6.

The described embodiments and their equivalents may be realized in software or hardware or a combination thereof. The embodiments may be performed by general purpose circuitry. Examples of general purpose circuitry include digital signal processors (DSP), central processing units (CPU), co-processor units, field programmable gate arrays (FPGA) and other programmable hardware. Alternatively or additionally, the embodiments may be performed by specialized circuitry, such as application specific integrated circuits (ASIC). The general purpose circuitry and/or the specialized circuitry may, for example, be associated with or comprised in an apparatus such as a communication device (e.g., a radio access node or a user equipment).

Embodiments may appear within an electronic apparatus (such as a communication device, e.g., a radio access node or a user equipment) comprising arrangements, circuitry, and/or logic according to any of the embodiments described herein. Alternatively or additionally, an electronic apparatus (such as a communication device, e.g., a radio access node or a user equipment) may be configured to perform methods according to any of the embodiments described herein.

According to some embodiments, a computer program product comprises a tangible, or non-tangible, computer readable medium such as, for example a universal serial bus (USB) memory, a plug-in card, an embedded drive or a read only memory (ROM). FIG. 7 illustrates an example computer readable medium in the form of a compact disc (CD) ROM 700. The computer readable medium has stored thereon a computer program comprising program instructions. The computer program is loadable into a data processor (PROC; e.g., data processing circuitry or a data processing unit) 720, which may, for example, be comprised in a communication device (e.g., a radio access node or a user equipment) 710. When loaded into the data processor, the computer program may be stored in a memory (MEM) 730 associated with or comprised in the data processor. According to some embodiments, the computer program may, when loaded into and run by the data processor, cause execution of method steps according to, for example, any of the methods illustrated in FIGS. 1A, 1B, and 3; or otherwise described herein.

Generally, all terms used herein are to be interpreted according to their ordinary meaning in the relevant technical field, unless a different meaning is clearly given and/or is implied from the context in which it is used.

Reference has been made herein to various embodiments. However, a person skilled in the art would recognize numerous variations to the described embodiments that would still fall within the scope of the claims.

For example, the method embodiments described herein discloses example methods through steps being performed in a certain order. However, it is recognized that these sequences of events may take place in another order without departing from the scope of the claims. Furthermore, some method steps may be performed in parallel even though they have been described as being performed in sequence. Thus, the steps of any methods disclosed herein do not have to be performed in the exact order disclosed, unless a step is explicitly described as following or preceding another step and/or where it is implicit that a step must follow or precede another step.

In the same manner, it should be noted that in the description of embodiments, the partition of functional blocks into particular units is by no means intended as limiting. Contrarily, these partitions are merely examples. Functional blocks described herein as one unit may be split into two or more units. Furthermore, functional blocks described herein as being implemented as two or more units may be merged into fewer (e.g. a single) unit.

Any feature of any of the embodiments disclosed herein may be applied to any other embodiment, wherever suitable. Likewise, any advantage of any of the embodiments may apply to any other embodiments, and vice versa.

Hence, it should be understood that the details of the described embodiments are merely examples brought forward for illustrative purposes, and that all variations that fall within the scope of the claims are intended to be embraced therein.

1-37. (canceled)

38. A method performed in a transmitter device configured for transmission of measurement signals for beam selection, the method comprising:
determining a collection of linear combinations of transmission beams, wherein the transmission beams are of a set of available transmission beams, wherein a cardinality, R, of the collection of linear combinations of transmission beams is lower than a cardinality, N, of the set of available transmission beams, wherein each transmission beam in the set of available transmission beams is comprised in at least one linear combination of transmission beams, and wherein at least one of the linear combinations of transmission beams comprises less than all transmission beams of the set of available transmission beams; and
transmitting measurement signals to a receiver device, wherein each of the measurement signals corresponds to a linear combination of transmission beams from the collection of linear combinations of transmission beams.

39. The method of claim 38, wherein determining the collection of linear combinations of transmission beams comprises determining the cardinality, R, of the collection of linear combinations of transmission beams based on the cardinality, N, of the set of available transmission beams, wherein the cardinality, R, of the collection of linear combinations of transmission beams is determined as the lowest R that satisfies N≤2^{R}−1.

40. The method of claim 38, wherein none of the linear combinations of transmission beams comprises all transmission beams of the set of available transmission beams.

41. The method of claim 38, further comprising allocating, for each linear combination of transmission beams, a respective transmission power for each transmission beam of the set of available transmission beams that is comprised in the linear combination of transmission beams, wherein a sum over the collection of linear combinations of transmission beams of the respective transmission powers allocated for a transmission beam is equal for all transmission beams of the set of available transmission beams.

42. The method of claim 41, wherein the respective transmission power for a transmission beam is inversely proportional to a number of linear combinations that the transmission beam is comprised in.

43. The method of claim 38, wherein determining the collection of linear combinations of transmission beams comprises:
selecting an l^{th} group of
$$( \begin{matrix}R \\ l\end{matrix} )$$
transmission beams from the set of N available transmission beams;
letting each transmission beam of the l^{th} group be comprised in exactly l of the linear combinations; and
letting each linear combination comprise exactly
$$( \begin{matrix}R - 1 \\ l - 1\end{matrix} )$$
transmission beams of the l^{th} group, wherein determining the collection of linear combinations of transmission beams comprises iterating for 1=1, . . . , L, wherein L≤R is the highest L that
$$satisfies {\sum }_{n = 1}^{L} ( \begin{matrix}R \\ n\end{matrix} ) \leq N .$$

44. The method of claim 46, wherein determining the collection of linear combinations of transmission beams further comprises:
selecting an (L+1)^{th} group of less than
$$( \begin{matrix}R \\ L\end{matrix} )$$
transmission beams from the set of N available transmission beams;
letting each transmission beam of the (L+1)^{th} group be comprised in exactly (L+1) of the linear combinations; and
letting each linear combination comprise at most
$$( \begin{matrix}R - 1 \\ L\end{matrix} )$$
transmission beams of the (L+1)^{th} group.

45. The method of claim 43, wherein each transmission beam in the set of available transmission beams is comprised in exactly one group.

46. The method of claim 38, wherein determining the collection of linear combinations of transmission beams comprises:
splitting the set of available transmission beams into two or more subsets of available transmission beams; and
determining separate collections of linear combinations of transmission beams for each of the subsets.

47. The method of claim 38, further comprising:
receiving a transmission beam selection measurement report from the receiver device;
selecting a transmission beam from the set of available transmission beams in accordance with the received transmission beam selection measurement report, and
transmitting a communication signal using the selected transmission beam.

48. The method of claim 38, wherein each of the linear combinations of transmission beams of the collection of linear combinations of transmission beams is a unique linear combination.

49. The method of claim 38, wherein transmitting the measurement signals that correspond to each of the linear combinations of transmission beams comprises one or more of:
transmitting, for each of the linear combinations of transmission beams of the collection of linear combinations of transmission beams, a measurement signal that corresponds to the linear combination of transmission beams in a respective transmission time resource, at least some of the respective time resources being different; and
transmitting, for each of the linear combinations of transmission beams of the collection of linear combinations of transmission beams, a measurement signal that corresponds to the linear combination of transmission beams in a respective transmission frequency resource, at least some of the respective frequency resources being different.

50. The method of claim 38, wherein the method is applied during a training phase for beam selection.

51. A method performed in a receiver device configured for performing measurements for beam selection, the method comprising:
receiving measurement signals from a transmitter device, wherein each of the measurement signals corresponds to a linear combination of transmission beams from a collection of linear combinations of transmission beams, wherein the transmission beams are of a set of available transmission beams, wherein a cardinality, R, of the collection of linear combinations of transmission beams is lower than a cardinality, N, of the set of available transmission beams, wherein each transmission beam in the set of available transmission beams is comprised in at least one linear combination of transmission beams, and wherein at least one of the linear combinations of transmission beams comprises less than all transmission beams of the set of available transmission beams; and
performing measurements for beam selection on the measurement signals, for selection of a transmission beam from the set of available transmission beams.

52. The method of claim 56, wherein performing measurements for beam selection comprises determining a quality metric for each transmission beam of the set of available transmission beams.

53. The method of claim 56, further comprising selecting a preferred transmission beam from the set of available transmission beams based on the measurements for beam selection, wherein selecting the preferred transmission beam comprises:
determining, for each transmission beam in the set of available transmission beams, an average received power over all measurement signals that correspond to linear combinations comprising the transmission beam; and
selecting a transmission beam that corresponds to a highest average received power as the preferred transmission beam.

54. The method of claim 56, further comprising:
transmitting a transmission beam selection measurement report to the transmitter device for selection of the transmission beam from the set of available transmission beams.

55. The method of claim 56, wherein performing measurements for beam selection comprises subjecting the received measurement signals to matched filtering based on the collection of linear combinations of transmission beams.

56. An apparatus configured for controlling transmission—from a transmitter device—of measurement signals for beam selection, the apparatus comprising controlling circuitry configured to cause:
determination of a collection of linear combinations of transmission beams, wherein the transmission beams are of a set of available transmission beams, wherein a cardinality, R, of the collection of linear combinations of transmission beams is lower than a cardinality, N, of the set of available transmission beams, wherein each transmission beam in the set of available transmission beams is comprised in at least one linear combination of transmission beams, and wherein at least one of the linear combinations of transmission beams comprises less than all transmission beams of the set of available transmission beams; and
transmission of measurement signals to a receiver device, wherein each of the measurement signals corresponds to a linear combination of transmission beams from the collection of linear combinations of transmission beams.

57. An apparatus configured for controlling performance of measurements for beam selection, the apparatus comprising controlling circuitry configured to cause:
reception of measurement signals from a transmitter device, wherein each of the measurement signals corresponds to a linear combination of transmission beams from a collection of linear combinations of transmission beams, wherein the transmission beams are of a set of available transmission beams, wherein a cardinality, R, of the collection of linear combinations of transmission beams is lower than a cardinality, N, of the set of available transmission beams, wherein each transmission beam in the set of available transmission beams is comprised in at least one linear combination of transmission beams, and wherein at least one of the linear combinations of transmission beams comprises less than all transmission beams of the set of available transmission beams; and
performance of measurements for beam selection on the measurement signals, for selection of a transmission beam from the set of available transmission beams.
